(19) United States
(12) Patent Application Publication
(10) Pub. No.: US 2025/0343836 A1
(43) Pub. Date: Nov. 6, 2025

(54) CONTENTION-BASED ACCESS TO P2P GROUP RESOURCE

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Vishnu Vardhan Ratnam, Plano, TX (US); Yue Qi, Plano, TX (US); Bilal Sadiq, Plano, TX (US)

(21) Appl. No.: 19/183,707

(22) Filed: Apr. 18, 2025

Related U.S. Application Data
(60) Provisional application No. 63/643,145, filed on May 6, 2024.
(60) Provisional application No. 63/643,756, filed on May 7, 2024.

(51) Int. Cl. H04L 67/1074; H04L 67/104

(52) U.S. Cl. CPC H04L 67/1078; H04L 67/1044

(57) ABSTRACT

Methods and apparatuses for contention-based access to a peer-to-peer (P2P) group resource. A method of wireless communication performed by a first station (STA) includes forming a P2P group with a second STA for P2P communication within the P2P group. The method includes receiving a message from an access point (AP), the message including information associated with allocation of resources within the P2P group. The method further includes accessing the resources allocated to the P2P group based on identification information associated with the allocation of resources within the P2P group.

### CROSS-REFERENCE TO RELATED APPLICATION(S) AND CLAIM OF PRIORITY

This application claims priority under 35 U.S.C. § 119(e) to U.S. Provisional Patent Application No. 63/643,145, filed on May 6, 2024, and U.S. Provisional Patent Application No. 63/643,756, filed on May 7, 2024, which are hereby incorporated by reference in their entirety.

### TECHNICAL FIELD

This disclosure relates generally to wireless communication, and more specifically to contention-based access to a peer-to-peer group resource.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for contention-based access to a peer-to-peer group resource.

In one embodiment, a method of wireless communication performed by a first station (STA) associated with an access point (AP) includes forming a P2P group with a second STA for P2P communication within the P2P group. The method includes receiving a message from an access point (AP), the message including information associated with allocation of resources within the P2P group. The method further includes accessing the resources allocated to the P2P group based on identification information associated with the allocation of resources within the P2P group.

In another embodiment, an AP comprises a processor configured to: receive, from a first STA, a message that includes identification information associated with allocation of resources within a P2P group formed by the first STA and a second STA; and generate a message including information associated with the allocation of resources within the P2P group. The AP further comprises a transceiver operably coupled with the processor. The transceiver is configured to transmit the message that includes the information associated with the allocation of resources within the P2P group.

In yet another embodiment, a first STA comprises: a transceiver; and a processor operably coupled with the transceiver. The processor is configured to: form a P2P group with a second STA for P2P communication within the P2P group; receive, via the transceiver, a message from an AP, the message including information associated with allocation of resources within the P2P group; and access the resources allocated to the P2P group based on identification information associated with the allocation of resources within the P2P group.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise,” as well as derivatives thereof, mean inclusion without limitation. The term “or” is inclusive, meaning and/or. The phrase “associated with”, as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example access point (AP) according to embodiments of the present disclosure;

FIG. 3 illustrates an example station (STA) according to embodiments of the present disclosure;

FIG. 4 illustrates an example of a network where infrastructure traffic and non-infrastructure traffic coexist according to embodiments of the present disclosure;

FIG. 5 illustrates an example of transmission opportunity (TXOP) allocation to a P2P group according to embodiments of the present disclosure;

FIG. 6 illustrates an example of contention among P2P stations (STAs) to access the channel during an allocated TXOP according to embodiments of the present disclosure;

FIG. 7 illustrates an example of network allocation vector (NAV) setup during TXOP allocation to a P2P group according to embodiments of the present disclosure;

FIG. 8 illustrates an example of identifying a P2P group where both members are associated with the same access point (AP) according to embodiments of the present disclosure;

FIG. 9 illustrates an example of identifying a P2P group where at least one member is not associated with the same AP according to embodiments of the present disclosure;

FIG. 10 illustrates an example of identifying a P2P group where two STAs are associated with two different APs in the same extended service set (ESS) according to embodiments of the present disclosure;

FIG. 11 illustrates an example of identifying a P2P group where two STAs are associated with two different APs in different ESSs according to embodiments of the present disclosure; and

FIG. 12 illustrates an example method performed by a STA according to embodiments of the present disclosure.

### DETAILED DESCRIPTION

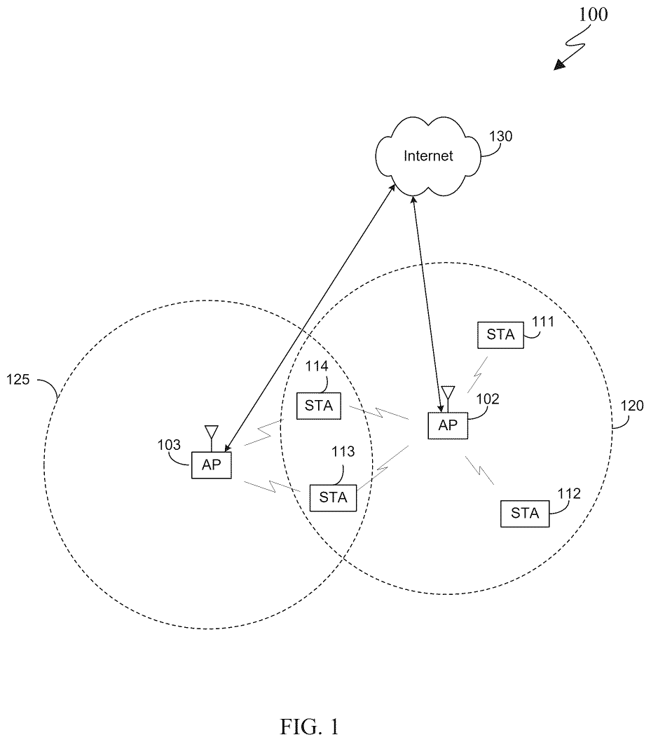

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP”, such as “router” or “gateway”. For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA”, such as “mobile station”, “subscriber station”, “remote terminal”, “user equipment”, “wireless terminal”, or “user device”. For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the APs may include circuitry and/or programming for facilitating contention-based access to a peer-to-peer group resource. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

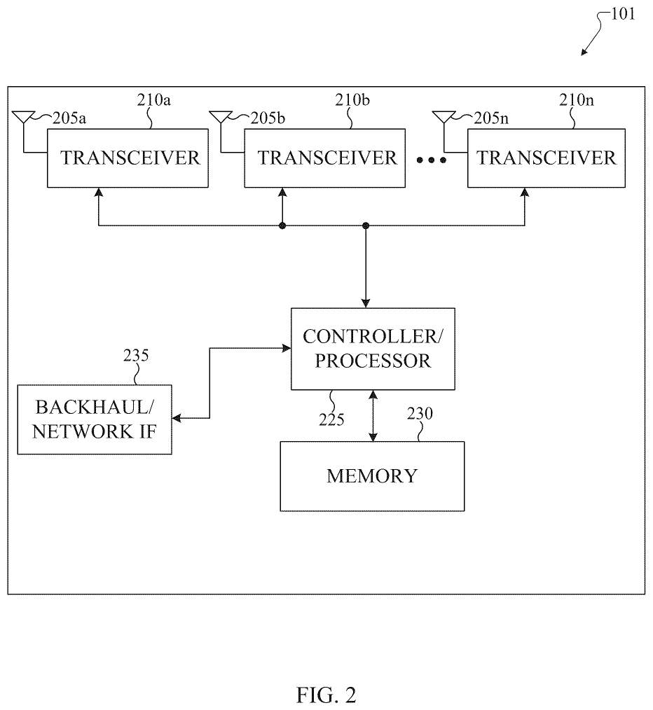

FIG. 2 illustrates an example AP 101 according to various embodiments of the present disclosure. The embodiment of the AP 101 illustrated in FIG. 2 is for illustration only, and the AP 103 of FIG. 1 could have the same or similar configuration. However, APs come in a wide variety of configurations, and FIG. 2 does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including facilitating contention-based access to a peer-to-peer group resource. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for facilitating contention-based access to a peer-to-peer group resource. Although FIG. 2 illustrates one example of AP 101, various changes may be made to FIG. 2. For example, the AP 101 could include any number of each component shown in FIG. 2. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2 could be combined, further subdivided, or omitted and additional components could be added according to particular needs.

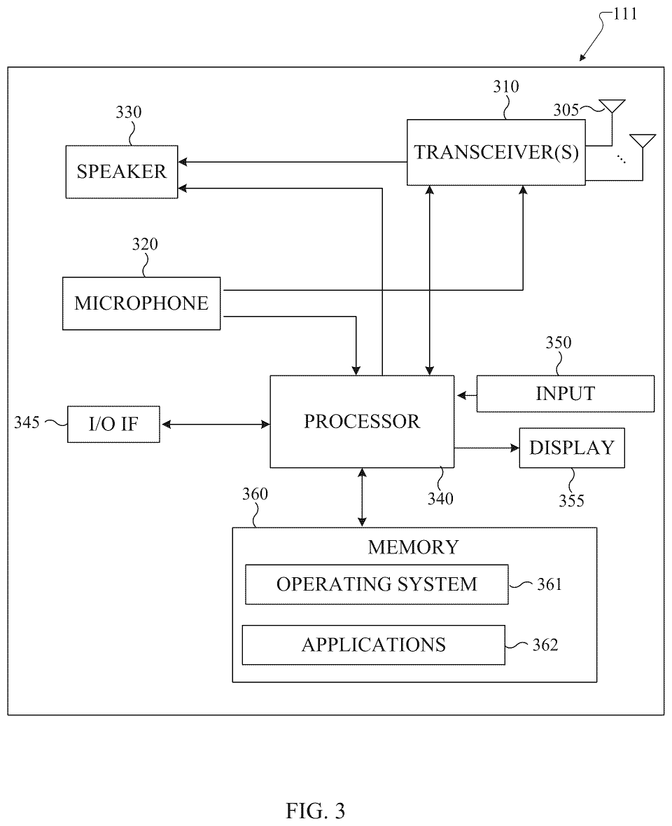

FIG. 3 illustrates an example STA 111 according to various embodiments of the present disclosure. The embodiment of the STA 111 illustrated in FIG. 3 is for illustration only, and the STAs 111-115 of FIG. 1 could have the same or similar configuration. However, STAs come in a wide variety of configurations, and FIG. 3 does not limit the scope of this disclosure to any particular implementation of a STA.

The STA 111 includes antenna(s) 305, transceiver(s) 310, a microphone 320, a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal (e.g., transmitted by an AP 101 of the network 100). The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors and execute the basic OS program 361 stored in the memory 360 in order to control the overall operation of the STA 111. In one such operation, the processor 340 controls the reception of forward channel signals and the transmission of reverse channel signals by the transceiver(s) 310 in accordance with well-known principles. The processor 340 can also include processing circuitry configured to facilitate contention-based access to a peer-to-peer group resource. In some embodiments, the processor 340 includes at least one microprocessor or microcontroller.

The processor 340 is also capable of executing other processes and programs resident in the memory 360, such as operations for facilitating contention-based access to a peer-to-peer group resource. The processor 340 can move data into or out of the memory 360 as required by an executing process. In some embodiments, the processor 340 is configured to execute a plurality of applications 362, such as applications for facilitating contention-based access to a peer-to-peer group resource. The processor 340 can operate the plurality of applications 362 based on the OS program 361 or in response to a signal received from an AP. The processor 340 is also coupled to the I/O interface 345, which provides STA 111 with the ability to connect to other devices such as laptop computers and handheld computers. The I/O interface 345 is the communication path between these accessories and the processor 340.

The processor 340 is also coupled to the input 350, which includes for example, a touchscreen, keypad, etc., and the display 355. The operator of the STA 111 can use the input 350 to enter data into the STA 111. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of STA 111, various changes may be made to FIG. 3. For example, various components in FIG. 3 could be combined, further subdivided, or omitted and additional components could be added according to particular needs. In particular examples, the STA 111 may include any number of antenna(s) 305 for MIMO communication with an AP 101. In another example, the STA 111 may not include voice communication or the processor 340 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

Embodiments of the present disclosure recognize that a next generation WLAN system needs to provide better support for low-latency applications. Today it is not uncommon to observe numerous devices operating on the same network. Many of such devices may be latency-tolerant but still contend with the devices with low-latency applications for the same time and frequency resources. In some cases, the access point (AP) as the network controller may not have enough control over the unregulated/unmanaged traffic that contend with the low-latency traffic within the infrastructure BSS. Some of the unmanaged traffic that interfere with the AP's BSS' latency sensitive traffic may be coming from uplink (UL)/downlink (DL) or direct link communications within the infrastructure BSS that the AP manages; others may be due to transmission in the neighboring infrastructure BSS (OBSS); yet others may be coming from neighboring independent BSS or P2P networks. The next generation WLAN system needs mechanisms to better handle the unmanaged traffic in order to prioritize the low-latency traffic in the network.

Embodiments of the present disclosure recognize that a P2P group is a collection of STAs that perform peer-to-peer communication within the group. An AP can allocate resources to a P2P group. However, the mechanism for accessing those resources needs to be defined

Embodiments of the present disclosure also recognize that two STAs can form a P2P link between them. The two STAs can be members of a P2P group. Currently, there is no mechanism for the AP to identify a P2P group.

Accordingly, various embodiments of the present disclosure can provide methods and apparatuses for a framework to access resources allocated from the AP by the STAs in a P2P group. Further, various embodiments of the present disclosure can provide methods and apparatuses for identifying a P2P group by the AP.

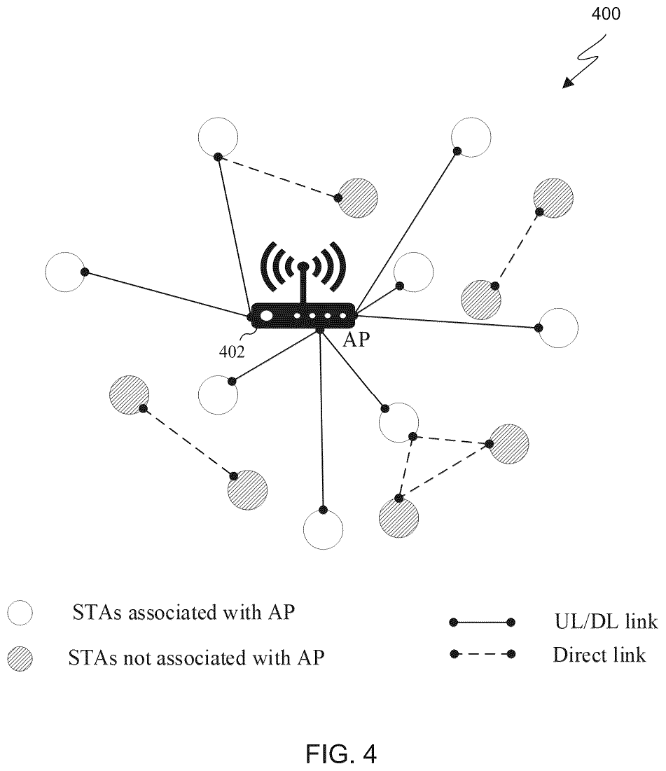

FIG. 4 illustrates an example of a network 400 where infrastructure traffic and non-infrastructure traffic coexist according to embodiments of the present disclosure. For example, the network 400 can be implemented in network 100 of FIG. 1. The embodiment of the example network 400 where infrastructure traffic and non-infrastructure traffic coexist shown in FIG. 4 is for illustration only. Other embodiments of the example network 400 where infrastructure traffic and non-infrastructure traffic coexist could be used without departing from the scope of this disclosure.

As illustrated in FIG. 4, the AP 402 as the network controller may not have enough control over the unregulated/unmanaged traffic that contend with the low-latency traffic within the infrastructure BSS. Some of the unmanaged traffic that interfere with the AP's BSS' latency sensitive traffic may be coming from uplink (UL)/downlink (DL) or direct link communications within the infrastructure BSS that the AP manages; others may be due to transmission in the neighboring infrastructure BSS (OBSS); yet others may be coming from neighboring independent BSS or P2P networks. FIG. 4 illustrates this kind of network.

According to some embodiments, a number of STAs can coordinate with each other and form a group for peer-to-peer communication among the STAs. Such a group can be referred to as a peer-to-peer group (P2P group).

According to some embodiments, a P2P group can be addressed by a unique identifier (ID). This ID can be referred to as a P2P Group ID (PGID). A PGID can be a MAC address.

According to some embodiments, a P2P group can be addressed by addressing its individual members/STAs. For this purpose, the AID or MAC addresses of the STAs in the P2P group can be used.

According to some embodiments, one or more STAs within a P2P group may not be associated with any AP.

According to some embodiments, two STAs that are members of a P2P group may be associated with two different APs.

According to some embodiments, at least one of the STAs in a P2P group may be associated with an AP.

According to some embodiments, an AP can send a trigger frame to a P2P group to allocate resources to the P2P group—
The trigger frame can be addressed to the P2P Group ID of that P2P group.
The trigger frame can be a form of MU-RTS trigger frame.
The trigger frame can be a form of MU-RTS TXS trigger frame.

According to some embodiments, the AP can indicate a TXOP allocation to the P2P group by sending the trigger frame.

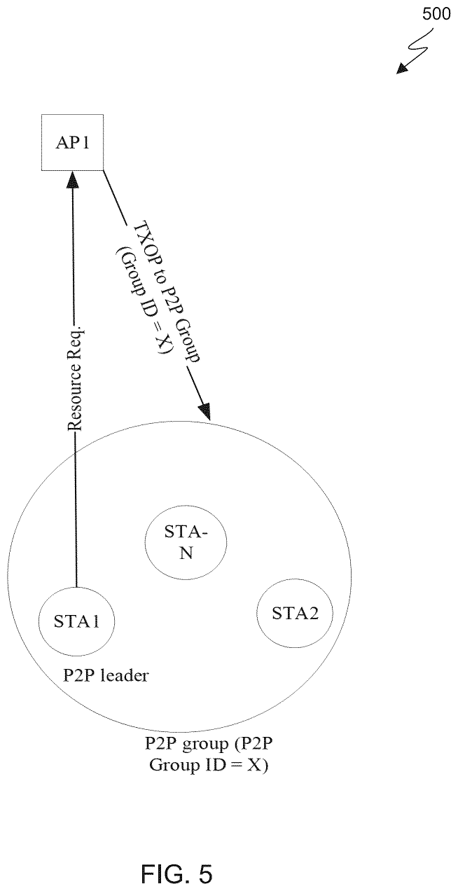

FIG. 5 illustrates an example of TXOP allocation to a P2P group 500 according to embodiments of the present disclosure. For example, the P2P group 500 can be implemented by STAs 111-114 and AP 101 of FIG. 1. The embodiment of the example of TXOP allocation to a P2P group 500 shown in FIG. 5 is for illustration only. Other embodiments of the example of TXOP allocation to a P2P group 500 could be used without departing from the scope of this disclosure.

According to some embodiments, to allocate TXOP to a P2P group, the AP can send a new mode of MU-RTS TXS Trigger frame and list the P2P Group ID as the User Info field of the trigger frame (i.e., the trigger frame recipient is a P2P group). This new mode of MU-RTS TXS Trigger frame can be referred to as a MU-RTS TXS Trigger frame (Mode-3) or P2P mode. This is illustrated in FIG. 5. Alternatively or in addition, the trigger frame can be a form of MU-RTS trigger frame.

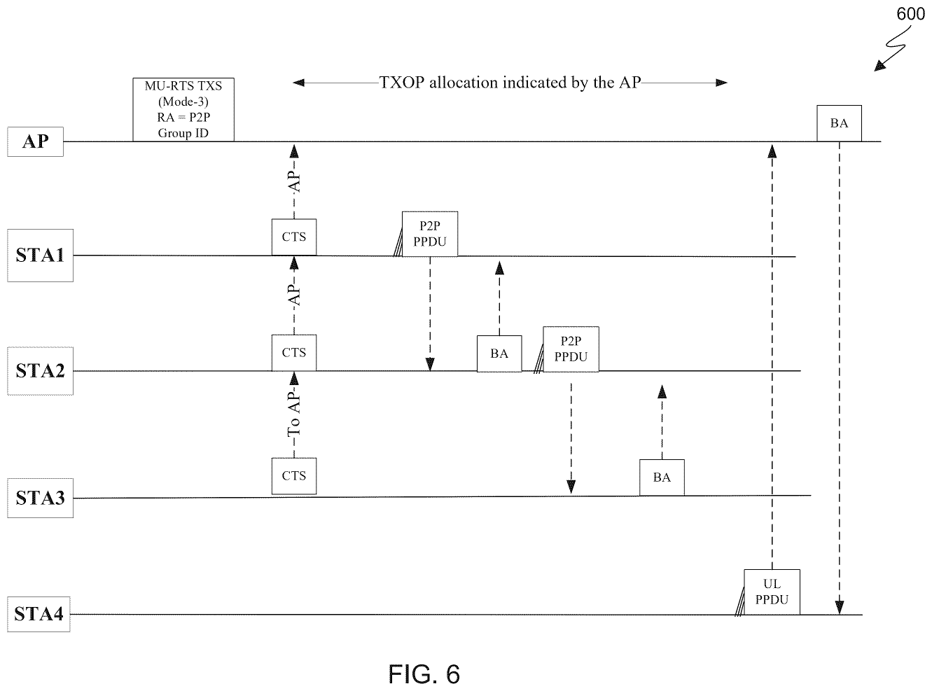

FIG. 6 illustrates an example of contention among P2P STAs to access the channel during an allocated TXOP 600 according to embodiments of the present disclosure. For example, contention among P2P STAs to access the channel during an allocated TXOP can be implemented by STAs 111-114 and AP 101 of FIG. 1. The embodiment of the example of contention among P2P STAs to access the channel during an allocated TXOP 600 shown in FIG. 6 is for illustration only. Other embodiments of the example of contention among P2P STAs to access the channel during an allocated TXOP 600 could be used without departing from the scope of this disclosure.

According to some embodiments, for the scenario where a first STA and a second STA are members of a first P2P group, if the AP allocates TXOP to the first P2P group, then the first STA and the second STA can contend (e.g., using enhanced distribution channel access (EDCA)) for the channel to access the medium during the allocated TXOP. A STA that is not part of the first P2P group may not contend to access the TXOP allocated by the AP. This embodiment is illustrated in FIG. 6. As shown in FIG. 6, STA1-STA3 are members of the P2P group and STA4 is not a member of the P2P group.

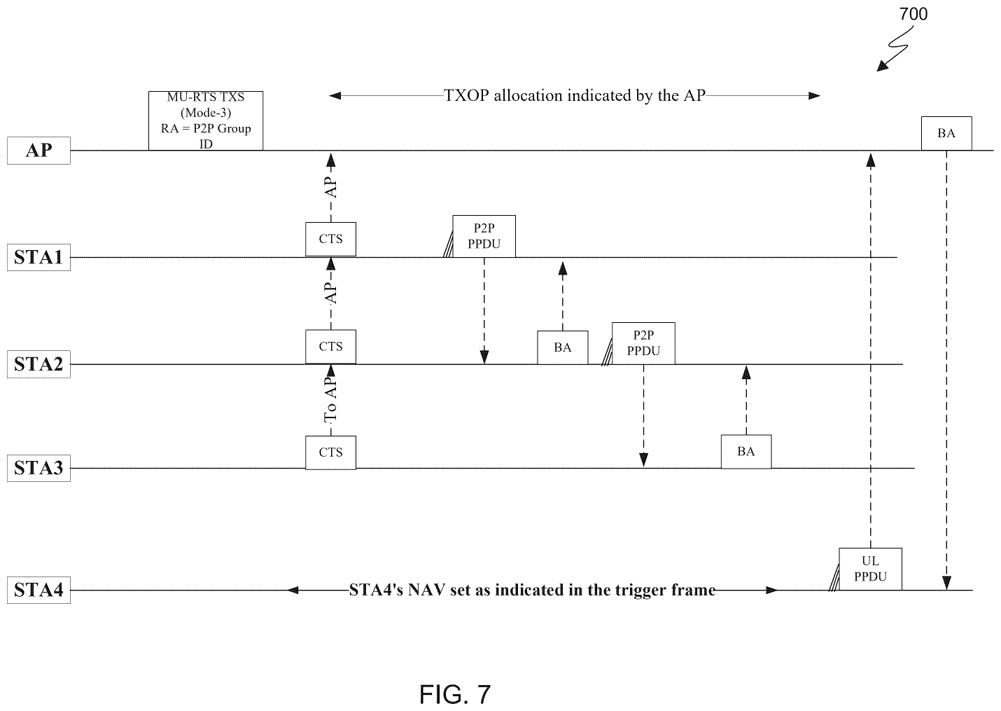

FIG. 7 illustrates an example of NAV setup during TXOP allocation to a P2P group 700 according to embodiments of the present disclosure. For example, NAV setup during TXOP allocation to a P2P group can be implemented by STAs 111-114 and AP 101 of FIG. 1. The embodiment of the example of NAV setup during TXOP allocation to a P2P group 700 shown in FIG. 7 is for illustration only. Other embodiments of the example of NAV setup during TXOP allocation to a P2P group 700 could be used without departing from the scope of this disclosure.

As illustrated in FIG. 7, according to some embodiments, when an AP sends a trigger frame, such as an MU-RTS TXS trigger frame, to a P2P group to allocate TXOP to the P2P group, if a first STA is a member of the P2P, then the first STA can ignore the NAV set by the trigger frame and start contending for the channel during the TXOP duration as indicated in the trigger frame.

As further illustrated in FIG. 7, according to some embodiments, when an AP sends a trigger frame to a P2P group to allocate TXOP to the P2P group, if a first STA is NOT a member of the P2P group, then the first STA can BSS NAV (or intra-BSS NAV) set by the trigger frame. During the entirety of the TXOP duration, the first STA may not contend for the channel.

According to some embodiments, a first STA and a second STA can be members of a P2P group, where either the first STA or the second STA can notify a first AP about the identification or existence of this P2P group. A P2P group can have a unique identifier, such as a P2P Group ID (PGID) or a unique MAC address.

According to some embodiments, for the scenario where a first STA is a member of a P2P group, if the first STA is associated with a first AP, then the first STA can send a message to the first AP, where the message can contain information on the identification or existence of the P2P group. For example, in a frame sent to the first AP, the first STA can contain an element, where the P2P Group ID is included as a field of this element.
According to some embodiments, for the scenario where a first STA is a member of a P2P group, if the first STA is NOT associated with a first AP, then the first STA can still send a message to the first AP, where the message can contain information on the identification of the P2P group. For example, in a frame sent to the first AP, the first STA can contain an element, where the P2P Group ID is included as a field of this element.
According to some embodiments, for the scenario where a first STA is a member of a P2P group, if the first STA is NOT associated with a first AP, then the first STA cannot send a message to the first AP, where the message can contain information on the identification of the P2P group. For example, in a frame sent to the first AP, the first STA can contain an element, where the P2P Group ID is not included as a field of this element.

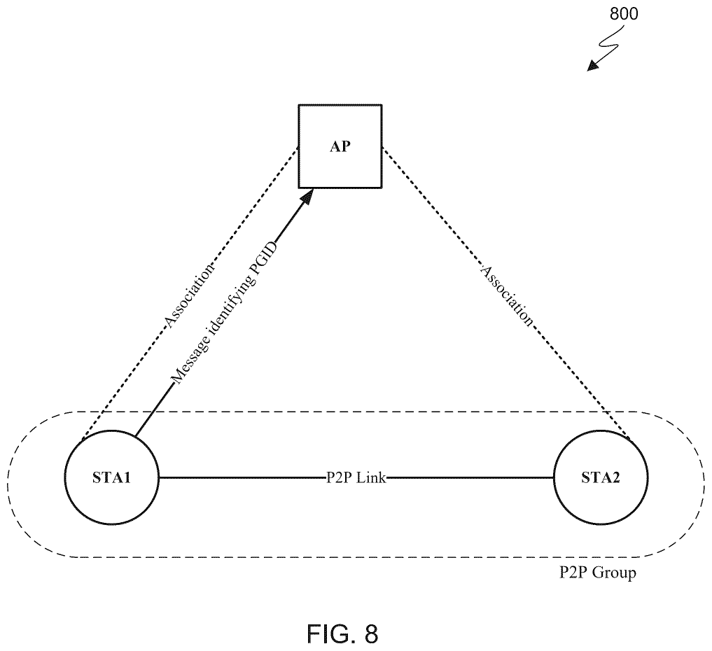

FIG. 8 illustrates an example of identifying a P2P group where both members are associated with the same AP 800 according to embodiments of the present disclosure. For example, identifying a P2P group where both members are associated with the same AP can be implemented by STAs 111-112 and AP 101 of FIG. 1. The embodiment of the example of identifying a P2P group where both members are associated with the same AP 800 shown in FIG. 8 is for illustration only. Other embodiments of the example of identifying a P2P group where both members are associated with the same AP 800 could be used without departing from the scope of this disclosure.

According to some embodiments, for the scenario where a first STA and a second STA are members of a P2P group, the first STA can inform the first AP about the identification or existence of the P2P group (e.g., by sharing the PGID of the group in a message identifying PGID) if both the first STA and the second STA are associated with the first AP. This is illustrated in FIG. 8.

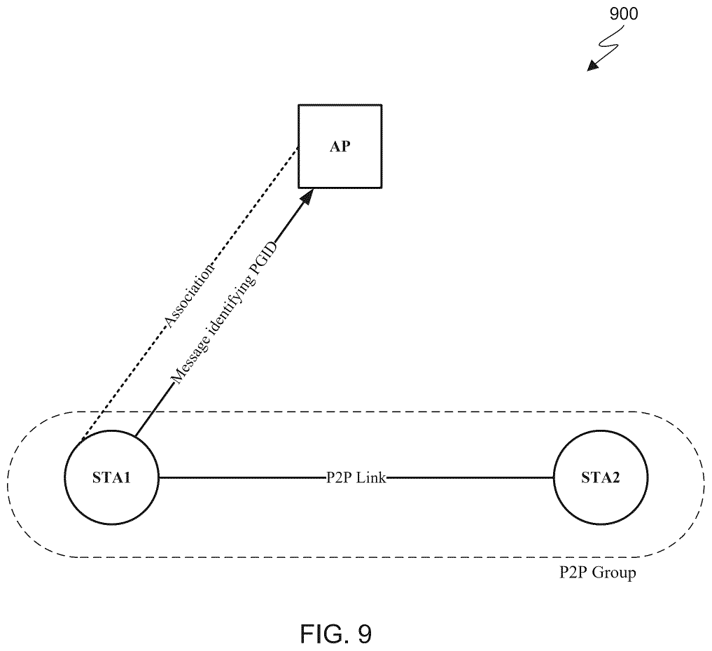

FIG. 9 illustrates an example of identifying a P2P group where at least one member is not associated with the same AP 900 according to embodiments of the present disclosure. For example, identifying a P2P group where at least one member is not associated with the same AP can be implemented by STAs 111-112 and AP 101 of FIG. 1. The embodiment of the example of identifying a P2P group where at least one member is not associated with the same AP 900 shown in FIG. 9 is for illustration only. Other embodiments of the example of identifying a P2P group where at least one member is not associated with the same AP 900 could be used without departing from the scope of this disclosure.

According to some embodiments, for the scenario where a first STA and a second STA are members of a P2P group, the first STA can inform the first AP about the identification or existence of the P2P group (e.g., by sharing the PGID of the group in a message identifying PGID) if the first STA is associated with the first AP—the second STA does not need to be associated with the first AP. This is illustrated in FIG. 9.

According to some embodiments, for the scenario where a first STA is a member of a P2P group, the first STA can inform the first AP about the identification of the P2P group (e.g., by sharing the PGID of the group in a message identifying PGID) if all the members of the P2P group are associated with the first AP.

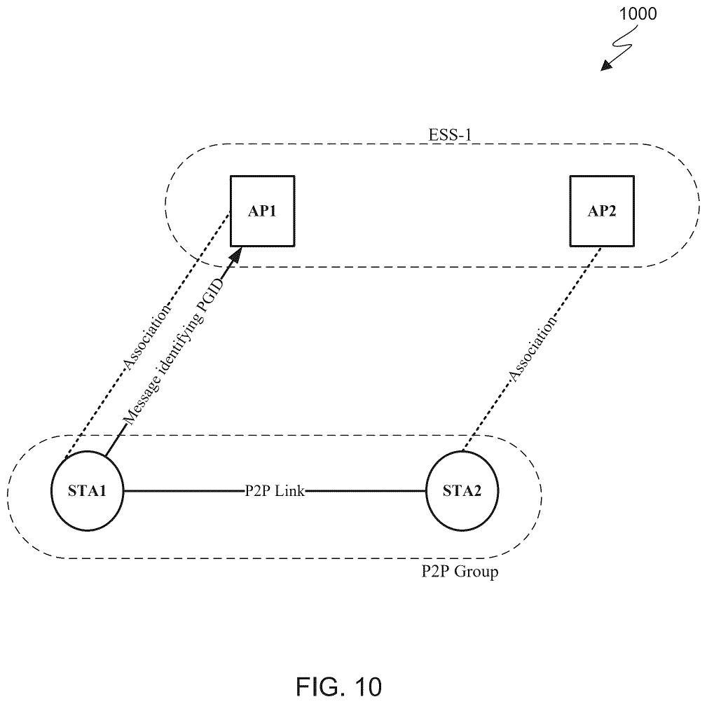

FIG. 10 illustrates an example of identifying a P2P group where two STAs are associated with two different APs in the same ESS 1000 according to embodiments of the present disclosure. For example, identifying a P2P group where two STAs are associated with two different APs in the same ESS can be implemented by STAs 111-112 and APs 101-103 of FIG. 1. The embodiment of the example of identifying a P2P group where two STAs are associated with two different APs in the same ESS 1000 shown in FIG. 10 is for illustration only. Other embodiments of the example of identifying a P2P group where two STAs are associated with two different APs in the same ESS 1000 could be used without departing from the scope of this disclosure.

According to some embodiments, for the scenario where a first STA and a second STA are members of a P2P group, the first STA can inform the first AP about the identification or existence of the P2P group (e.g., by sharing the PGID of the group in a message identifying PGID) if the first STA is associated with the first AP—the second STA may be associated with a second AP. According to some embodiments, the first AP and the second AP may belong to the same ESS. This is illustrated in FIG. 10.

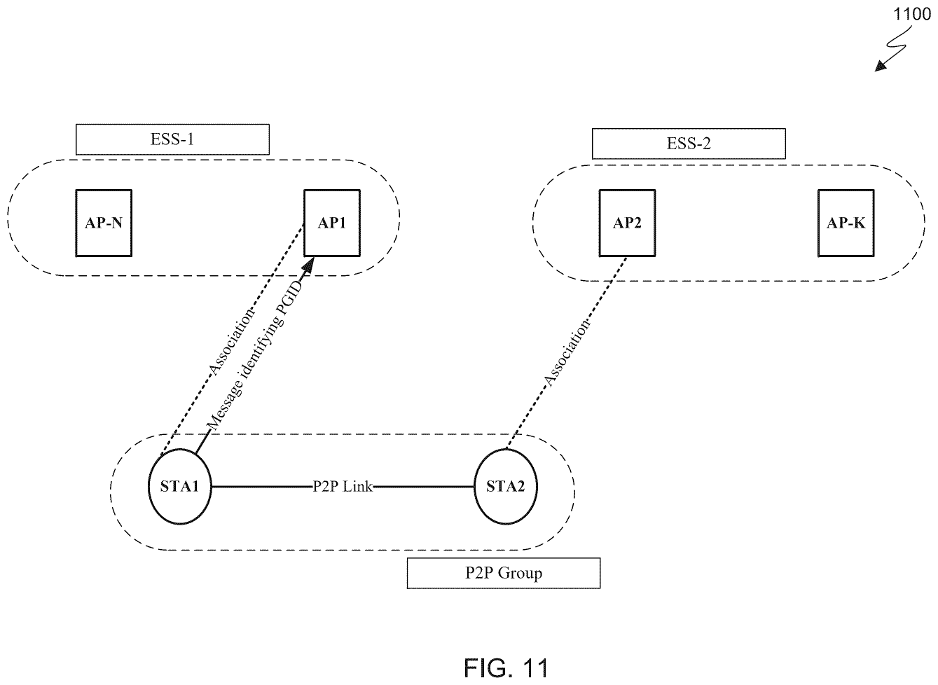

FIG. 11 illustrates an example of identifying a P2P group where two STAs are associated with two different APs in different ESSs 1100 according to embodiments of the present disclosure. For example, identifying a P2P group where two STAs are associated with two different APs in different ESSs can be implemented by STAs 111-112 and APs 101-103 of FIG. 1. The embodiment of the example of identifying a P2P group where two STAs are associated with two different APs in different ESSs 1100 shown in FIG. 11 is for illustration only. Other embodiments of the example of identifying a P2P group where two STAs are associated with two different APs in different ESSs 1100 could be used without departing from the scope of this disclosure.

According to some embodiments, the first AP and the second AP may belong to different ESS. For example, for the scenario where a first STA and a second STA are members of a P2P group, the first STA can inform the first AP about the identification or existence of the P2P group (e.g., by sharing the PGID of the group in a message identifying PGID) if the first STA is associated with the first AP—the second STA may be associated with a second AP in a different ESS. This is illustrated in FIG. 11.

According to some embodiments, for the scenario where a first STA is a member of a P2P group, the first STA can inform the first AP about the identification or existence of the P2P group. For identifying the P2P group, the first STA can send a message to the first AP, where the message may contain information on the following:
An identifier of the P2P group. For example, P2P Group ID.
A MAC address used by the members of the P2P group to communicate with the AP.
A list of identifiers that identify the members of the P2P group. In this aspect, the AID of the member STAs can be shared with the AP. Alternatively, the MAC address or the MLD MAC address of the member STA or member MLDs of can be shared with the AP.
A list of identifiers of the STAs that are associated with the same AP to whom the message is sent.
A list of identifiers of the STAs that are associated with the APs in the same ESS as the AP to whom the message is sent.
A number of STAs in the P2P group that are not associated with the AP to whom the message is sent.
A set of capabilities of the members of the STAs that are members of the P2P group.

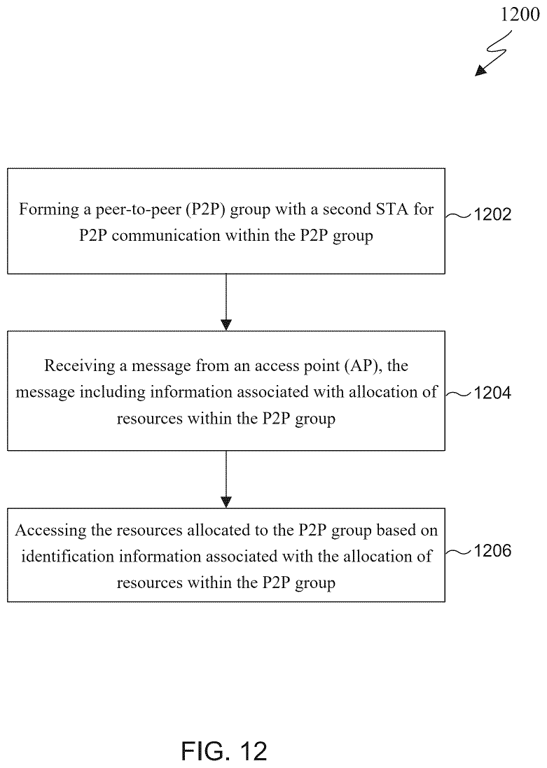

FIG. 12 illustrates an example method 1200 performed by STA in a wireless communication system according to embodiments of the present disclosure. For example, the method 1200 of FIG. 12 can be performed by any of the STAs 111-114 of FIG. 1, such as the STA 111 of FIG. 3, and a corresponding method can be performed by any of the APs 101-103 of FIG. 1, such as AP 101 of FIG. 2. The method 1200 is for illustration only and other embodiments can be used without departing from the scope of the present disclosure.

As illustrated in FIG. 12, the method 1200 begins at step 1202, where the first STA forms a P2P group with a second STA for P2P communication within the P2P group. At step 1204, the first STA receives a message from an AP, the message including information associated with allocation of resources within the P2P group. At step 1206, the first STA accesses the resources allocated to the P2P group based on identification information associated with the allocation of resources within the P2P group.

In some embodiments, the identification information comprises: an identifier associated with addressing the P2P group as a whole; or a respective identifier associated with a corresponding STA of the P2P group for addressing each STA of the P2P group individually.

In some embodiments, receiving the message from the AP comprises receiving a trigger frame to allocate resources to the P2P group. The trigger frame is: addressed to an identifier associated with addressing the P2P group as a whole; or a form of MU-RTS trigger frame; or a form of MU-RTS TXS trigger frame.

In some embodiments, the first STA transmits a request to the AP to allocate resources to the P2P group, where: receiving the message from the AP comprises receiving a trigger frame to allocate a TXOP to the P2P group; and the identification information comprises an identifier associated with identifying the P2P group as a whole.

In some embodiments, the information associated with the allocation of resources comprises a transmit opportunity (TXOP); and the first STA contends, with the second STA, to access the TXOP allocated by the AP.

In some embodiments, the first STA transmits a message to the AP for identifying the P2P group, where the message for identifying the P2P group includes a unique identifier associated with addressing the P2P group as a whole.

In some embodiments, the first STA transmits a message to the AP for identifying the P2P group, where the message for identifying the P2P group includes one or more of: a unique identifier associated with addressing the P2P group as a whole; a media access control address used by members of the P2P group to communicate with the AP; a list of identifiers that identify members of the P2P group; a list of identifiers of STAs that are associated with the AP; a list of identifiers of STAs that are associated with APs in a same extended service set as the AP; and a number of STAs in the P2P group that are not associated with the AP.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by a first station (STA), the method comprising:
forming a peer-to-peer (P2P) group with a second STA for P2P communication within the P2P group;
receiving a message from an access point (AP), the message including information associated with allocation of resources within the P2P group; and
accessing the resources allocated to the P2P group based on identification information associated with the allocation of resources within the P2P group.

2. The method of claim 1, wherein the identification information comprises:
an identifier associated with addressing the P2P group as a whole; or
a respective identifier associated with a corresponding STA of the P2P group for addressing each STA of the P2P group individually.

3. The method of claim 1, wherein:
receiving the message from the AP comprises receiving a trigger frame to allocate resources to the P2P group; and
the trigger frame is:
addressed to an identifier associated with addressing the P2P group as a whole; or
a form of multiuser request-to-send (MU-RTS) trigger frame; or
a form of MU-RTS transmit opportunity sharing (TXS) trigger frame.

4. The method of claim 1, further comprising transmitting a request to the AP to allocate resources to the P2P group, wherein:
receiving the message from the AP comprises receiving a trigger frame to allocate a transmit opportunity (TXOP) to the P2P group; and
the identification information comprises an identifier associated with identifying the P2P group as a whole.

5. The method of claim 1, wherein:
the information associated with the allocation of resources comprises a transmit opportunity (TXOP); and
the method further comprises contending, with the second STA, to access the TXOP allocated by the AP.

6. The method of claim 1, further comprising transmitting a message to the AP for identifying the P2P group, wherein the message for identifying the P2P group includes a unique identifier associated with addressing the P2P group as a whole.

7. The method of claim 1, further comprising transmitting a message to the AP for identifying the P2P group, wherein the message for identifying the P2P group includes one or more of:
a unique identifier associated with addressing the P2P group as a whole;
a media access control address used by members of the P2P group to communicate with the AP;
a list of identifiers that identify members of the P2P group;
a list of identifiers of STAs that are associated with the AP;
a list of identifiers of STAs that are associated with APs in a same extended service set as the AP; and
a number of STAs in the P2P group that are not associated with the AP.

8. An access point (AP), comprising:
a processor configured to:
receive, from a first station (STA), a message that includes identification information associated with allocation of resources within a peer-to-peer (P2P) group formed by the first station (STA) and a second STA; and
generate a message including information associated with the allocation of resources within the P2P group; and
a transceiver operably coupled with the processor, the transceiver configured to transmit the message that includes the information associated with the allocation of resources within the P2P group.

9. The AP of claim 8, wherein the identification information comprises:
an identifier associated with addressing the P2P group as a whole; or
a respective identifier associated with a corresponding STA of the P2P group for addressing each STA of the P2P group individually.

10. The AP of claim 8, wherein:
the message that includes the information associated with the allocation of resources within the P2P group comprises a trigger frame to allocate resources to the P2P group; and
the trigger frame is:
addressed to an identifier associated with addressing the P2P group as a whole; or
a form of multiuser request-to-send (MU-RTS) trigger frame; or
a form of MU-RTS transmit opportunity sharing (TXS) trigger frame.

11. The AP of claim 8, wherein:
the processor is configured to receive, via the transceiver, a request to allocate resources to the P2P group;
the transceiver is configured to transmit a trigger frame to allocate a transmit opportunity (TXOP) to the P2P group; and
the identification information comprises an identifier associated with identifying the P2P group as a whole.

12. The AP of claim 8, wherein the information associated with the allocation of resources comprises a transmit opportunity (TXOP).

13. The AP of claim 8, wherein the processor is configured to receive, via the transceiver, a message for identifying the P2P group, wherein the message for identifying the P2P group includes one or more of:
a unique identifier associated with addressing the P2P group as a whole;
a media access control address used by members of the P2P group to communicate with the AP;
a list of identifiers that identify members of the P2P group;
a list of identifiers of STAs that are associated with the AP;
a list of identifiers of STAs that are associated with APs in a same extended service set as the AP; and
a number of STAs in the P2P group that are not associated with the AP.

14. A first station (STA), comprising:
a transceiver; and
a processor operably coupled with the transceiver, the processor configured to:
form a peer-to-peer (P2P) group with a second STA for P2P communication within the P2P group;
receive, via the transceiver, a message from an access point (AP), the message including information associated with allocation of resources within the P2P group; and
access the resources allocated to the P2P group based on identification information associated with the allocation of resources within the P2P group.

15. The first STA of claim 14, wherein the identification information comprises:
an identifier associated with addressing the P2P group as a whole; or
a respective identifier associated with a corresponding STA of the P2P group for addressing each STA of the P2P group individually.

16. The first STA of claim 14, wherein:
to receive the message from the AP, the processor is configured to receive a trigger frame to allocate resources to the P2P group; and
the trigger frame is:
addressed to an identifier associated with addressing the P2P group as a whole; or
a form of multiuser request-to-send (MU-RTS) trigger frame; or
a form of MU-RTS transmit opportunity sharing (TXS) trigger frame.

17. The first STA of claim 14, wherein:
the processor is configured to cause the transceiver to transmit a request to the AP to allocate resources to the P2P group;
to receive the message from the AP, the processor is configured to receive a trigger frame to allocate a transmit opportunity (TXOP) to the P2P group; and
the identification information comprises an identifier associated with identifying the P2P group as a whole.

18. The first STA of claim 14, wherein:
the information associated with the allocation of resources comprises a transmit opportunity (TXOP); and
the processor is configured to cause the first STA to contend, with the second STA, to access the TXOP allocated by the AP.

19. The first STA of claim 14, wherein:
the processor is configured to cause the transceiver to transmit a message to the AP for identifying the P2P group; and
the message for identifying the P2P group includes a unique identifier associated with addressing the P2P group as a whole.

20. The first STA of claim 14, wherein:
the processor is configured to cause the transceiver to transmit a message to the AP for identifying the P2P group; and
the message for identifying the P2P group includes one or more of:
a unique identifier associated with addressing the P2P group as a whole;
a media access control address used by members of the P2P group to communicate with the AP;
a list of identifiers that identify members of the P2P group;
a list of identifiers of STAs that are associated with the AP;
a list of identifiers of STAs that are associated with APs in a same extended service set as the AP; and
a number of STAs in the P2P group that are not associated with the AP.
